(19) United States
(12) Patent Application Publication
(10) Pub. No.: US 2006/0262316 A1
(43) Pub. Date: Nov. 23, 2006

(54) System and method for interferometric laser photoacoustic spectroscopy

(76) Inventor: Douglas M. Baney, Los Altos, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/133,968

(22) Filed: May 20, 2005

(51) Int. Cl. G01B 9/02

(52) U.S. Cl. 356/451

(57) ABSTRACT

A system of using an interferometer, in combination with a laser, and a detector to determine absorptive characteristics of a material under test. The operation of the interferometer allows for determination of the wavelength of the laser beam and for determining relative changes in the wavelength of the laser beam. A method for using a laser source and an interferometer to determine characteristics of a material under test in accordance with the present invention is also provided.

### DESCRIPTION OF RELATED ART

Molecular spectroscopy has been widely practiced in the mid-IR (infrared red) range, by a technique referred to as Fourier Transform Infrared Reflectometry (FTIR). FTIR provides for analyzing a sample using a hot glow bar in conjunction with a scanning autocorrelator and cooled detectors. As the autocorrelator mirror is scanned in distance, the absorption signature of the unknown molecule is measured via Fourier Transform of the measured cooled detector output. This FTIR technology is widely used as a tool of choice for determining the presence of certain molecules.

The FTIR approach has some limitations. For example, FTIR suffers from poor sensitivity due to the limited spectral density of the glowbar. Additionally, the use of cooled detectors generally means that FTIR systems are complex and large in size, and have significant power dissipation requirements.

Another approach which is sometimes used instead of the glowbar/FTIR approach, provides for utilizing a tunable narrow line width laser diode, where the laser frequency (the output wavelength) is scanned. The laser beam is passed through an absorptive analyte gas and then detected by either a cooled detector, or given the high powers available from lasers such QCL lasers, by use of intensity pulsing in conjunction with a photoacoustic detector. This method offers high sensitivity, capable of measuring gasses in concentrations below 100 ppb. However, when using laser technology it can be a significant challenge to accurately and efficiently determine the absolute wavelength of the output laser beam, and to determine relative changes in the wavelength of the output laser beam. Present developments in tunable laser technology suggest that tunable lasers having wavelengths in the range of between 3 to 30 microns, will be available, and such wavelength ranges are well suited for use in molecular spectroscopy. Thus, provided herein are a range of embodiments which provide for overcoming some of the challenges associated with prior systems using scanned lasers in molecular spectroscopy systems.

### BRIEF DESCRIPTION OF THE DRAWINGS

FIG. 1A shows an embodiment of system having a tunable interferometer.

FIG. 1B illustrates an aspect of the operation of the system shown in FIG. 1A.

FIG. 1C shows an output of the system shown in FIG. 1A.

FIG. 2A show an embodiment of a system herein.

FIG. 2B illustrates an aspect of the operation of the system shown in FIG. 2A.

FIG. 3 shows an alternative embodiment a system herein which utilizes two separate photoacoustic cells.

FIG. 4 shows an alternative embodiment a system herein, which utilizes photoacoustic cells disposed in a branch of an interferometer.

FIG. 5 shows an embodiment of a method herein.

### DETAILED DESCRIPTION

When using a tunable laser in molecular spectroscopy a significant challenge can be determining the optical frequency, or wavelength, of the output laser beam. Optical frequency is important since the absorption signatures of various molecules depend on frequency, so errors in frequency can translate to misidentification of the molecule. In the IR wavelength range between 3 and 30 microns, tunable narrow linewidth lasers can sometimes abruptly change frequency, i.e. mode-hop, so there is a need not only to be able to determine relative frequency, or wavelength changes, but also to determine the absolute wavelength. An embodiment herein allows for absolute and relative frequency determinations for measurements of absorptive material. In an embodiment herein a photoacoustic detection arrangement allows for determination of the wavelength of the laser, even in the presence of global mode-hops in the energy output by the laser, which can occur as the laser is accessing different parts of the IR spectrum, for example in the range of 3 to 30 microns. An embodiment herein also provides for continuous monitoring of the laser beam so that relative changes in the wavelength of the laser beam can be determined as the wavelength is being swept across a spectrum range.

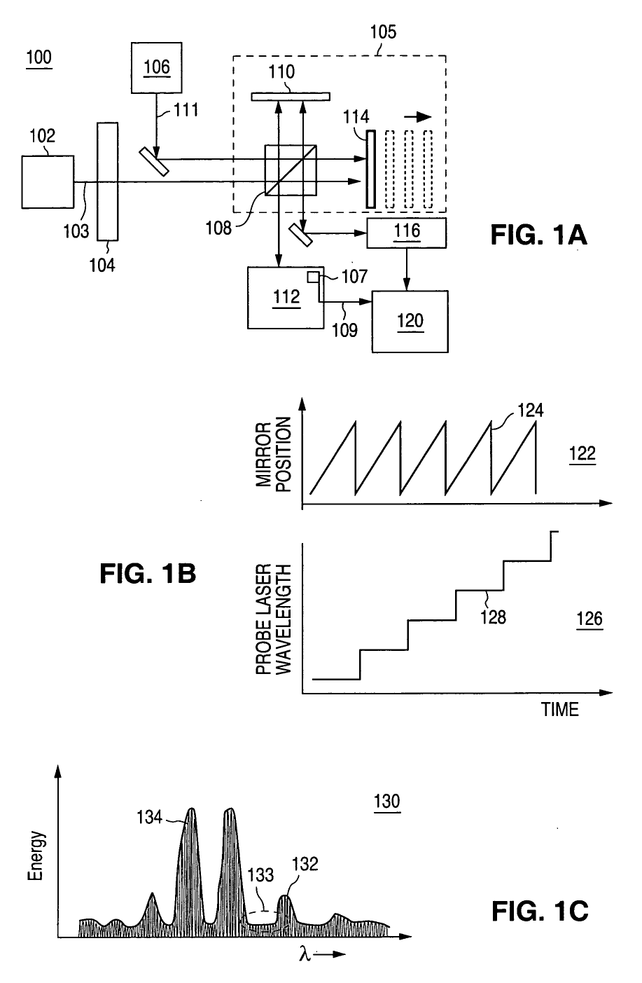

FIG. 1A shows an embodiment of a system 100 herein. A laser source 102 is provided, which outputs a laser beam 103. It should be noted depending on the particular embodiment, the laser source could be any device incorporating amplification of stimulated emission or amplified spontaneous emissions, where the output spectrum could be dominated by either amplified stimulated emission or amplified spontaneous emission, where the source can provide a narrow line width output, or a broad line width output. The laser beam 103 is transmitted through a collimation lens 104. The laser beam 103 is then transmitted through an interferometer 105. An interferometer is a device which operates to separate and then recombine energy of a laser beam. The recombined laser beam can then be used determine properties of the laser beam, or conversely if the properties of the laser beam are known, then properties of the interferometer can be determined from the fringe pattern of the recombined laser beam. As shown in FIG. 1A the interferometer 105 is a tunable interferometer. The laser beam 103 is incident on a beam splitter 108 of the interferometer. A portion of the laser beam 103 is reflected to a fixed mirror 110 of the interferometer. Another portion of the laser beam 103 is transmitted through the beam splitter 108, to a movable mirror 114 of the interferometer. The portions of the laser beam 103 which are incident on the mirrors 110 and 114 are then reflected back to the beam splitter 108, where the beams area recombined and then transmitted as a recombined beam into a photoacoustic cell 112. In one embodiment the photoacoustic cell 112 contains a material which is being analyzed, sometimes referred to as an analyte, which is typically a gas. As one of skill in the art will recognize a photoacoustic cell is well known. Depending on the particular characteristics of the material being analyzed, the material may absorb energy from the laser beam, depending on the wavelength of the laser beam. When energy from the laser beam is absorbed by a material in the photoacoustic cell 112, the material will then subsequently emit the absorbed energy as acoustic waves, and this emission can then be sensed either directly, or indirectly, by one or more detectors 107 disposed to in the photoacoustic cell 112. Detectors 107 may be configured into an array to obtain a spatial image of the analyte allowing chemical identification as a function of spatial position.

The detector 107, which in one embodiment is a photoacoustic detector, outputs an energy absorption signal 109 which is transmitted to a processor of a computer 120. The processor is programmed to analyze the absorption energy signal and then based on the absorption qualities of the material in photoacoustic cell, characteristics such as the composition of the material in cell can be determined.

FIG. 1A illustrates that movable mirror 114 of the interferometer is scanned through a range of positions, and this movement of the mirror is coordinated with the changing of the wavelength of the narrow line width laser beam 103 output by the laser 102. FIG. 1B provides graphs 122 and 126 which further illustrate this operation. In graph 126 the wavelength of the laser beam 103 output by the laser 102 is held at a fixed wavelength for a period of time. During the period of time that the wavelength is fixed, the mirror 114 is swept through a range of different positions, as is represented by the line 124 of graph 122. As one of skill in the art will recognize, movement of the mirror 114 will cause the recombined laser beam transmitted from the beam splitter 108 to the photoacoustic cell 112, to have a series of interference fringes. The series of interference fringes are sensed by the detector 107 in the photoacoustic cell, when the material disposed in the cell absorbs energy from the laser beam which is transmitted into the cell. Thus, as mirror scans through its range of positions, the detector 107 will transmit the energy absorption signal 109 to the computer 120, which can then analyze the fringe pattern of the signal to determine the wavelength of the laser beam 103.

FIG. 1C shows the output of an absorption energy signal 109 of the photoacoustic cell 112, which would be transmitted to the computer 120 from the detector 107. The curve 132 of graph 130 shows the envelop of the output from the detector 107 which corresponds to the absorptive properties of the material disposed in the photoacoustic cell 112 at different input laser beam wavelengths. Underlying the envelope 132 is the fringe information 134 which the computer can analyze to precisely determine wavelength of the laser beam input to the photoacoustic cell 112. The vertical axis corresponds to an energy sensed by the detector 107, where the energy was absorbed by the molecules of the material in the photoacoustic cell 112, and then the energy is subsequently emitted from the molecules. This emitted energy could be sensed in the form of a pressure increase, or other photoacoustic type effect as is known in the art. In a photoacoustic spectroscopy system using a laser, the input laser beam is usually pulsed, so as to established a resonant photoacoustic effect. However, in one embodiment of the present invention the laser beam 103 initially generated by the laser source 102 need not be pulsed, because interferometer 105 can operate to create a pulsed laser beam by displacing the position of the mirror 114 so that the interference of the combined components of the laser beam results in constructive and destructive interference which creates an intensity-modulated beam input to the photoacoustic cell 112. In another embodiment, the laser source could provide for the pulsing of the laser beam.

In some embodiments of the present invention it can be difficult to obtain sufficient fringe data information from the photoacoustic cell, when the material in the photoacoustic cell does not absorb a sufficient amount of the laser beam energy. For example, in FIG. 1C, in the area of the graph 133, there signal obtained from the photoacoustic cell is fairly weak which can make it difficult to discern the wavelength information. In general for an absorption fingerprint as shown in FIG. 1C, this would not create a difficulty in terms of the identifying the molecular make up of the analyte, because normally the most important wavelengths to accurately identify are those wavelengths where the analyte is strongly, as opposed to weakly, absorptive. FIG. 3 which is discussed in more detail below provides an alternative system which can be used in situations where the analyte under study is weakly absorptive over much of the wavelength spectrum of interest.

In one embodiment the underlying fringe information 134 is processed using a Fourier transformation and analysis to make the wavelength determination. The laser pulse rate should be sufficiently fast compared to the fringe rate, as determined by the Nyquist sampling. The system 100, can optionally include a reference laser 106 (such as HeNe gas laser or stabilized semiconductor laser) which outputs a stable known wavelength laser beam 111. The laser beam 111 from the reference laser is then transmitted through the interferometer 105 and received by a reference detector 116, which could be a silicon photodetector. The output of the reference detector 116 is then input to the computer 120. Because the wavelength of the laser beam 111 output by the reference laser is known, the series of fringe patterns detected by the reference detector can be analyzed to precisely determine the position of the mirror, whereby the effect of a potential variable in the system, the position of the movable mirror 114, can be precisely known and accounted for in determining the wavelength of the probe beam 103 output by the laser 102.

In one embodiment of the system 100 the laser 102 could provide a pulsed output laser beam. In such an embodiment the movable mirror 114 of the interferometer could be held stationary, while the laser beam 103 is pulsed by the laser 102 to allow for acoustic resonance in the photoacoustic cell, whereby the mirror fringes area held stationary with respect to the laser beam pulses input to the photoacoustic cell 112.

It should be recognized that a number of different lasers could be used in the system herein to provide the laser beam 103. One laser which could be used is a quantum cascade laser, which is generally referred to a QCL or a QC laser. The QC laser can output narrow line width (<100 GHz) laser beam wavelengths in the desired mid-IR range and is tunable, or alternatively having a broad lineshape (>100 GHz) dominated by spontaneous emission so that wavelength scanning is not required, and Fourier transformation of the scanned interferometer data is used to obtain the absorption envelop. Another laser source, provided in an embodiment herein, that can be used for chemical analysis, is a multi-section laser which uses a super sampled grating structure to provide a tunable narrow line width wavelength laser beam. If this super sampled grating structure is placed into a unipolar quantum cascade gain medium, tunable laser operation with mode hops can be attained in the mid-IR range. This would allow for tunable laser operation as has been demonstrated in the direct-bandgap laser structures used and widely know in the telecom industry.

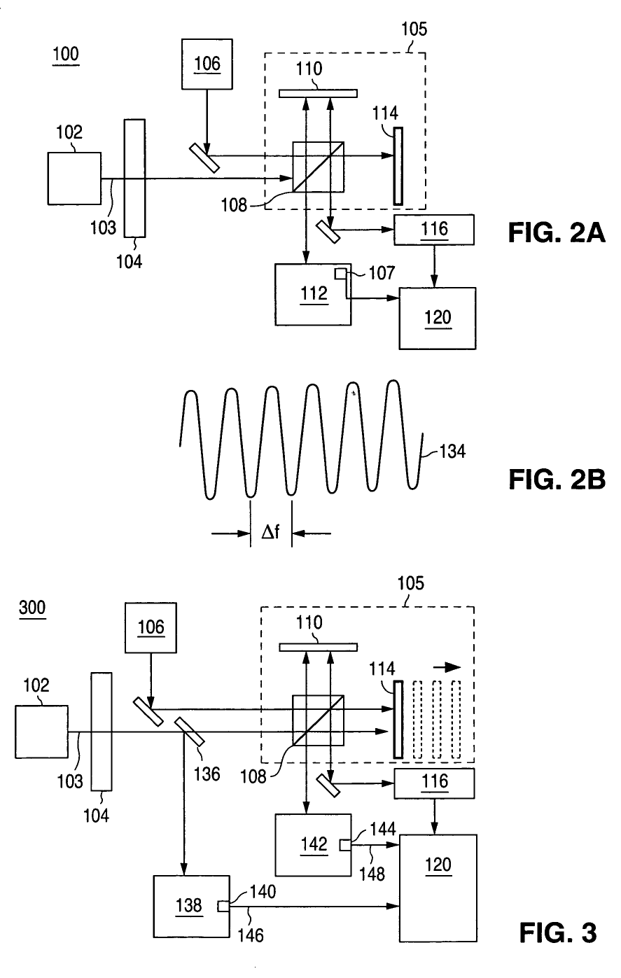

FIG. 2A illustrates another aspect of the operation of the system 100 shown in FIG. 1A. In FIG. 2A, the system 100 is operating in a mode where the movable mirror 114 is in a fixed position. In one method of operation the position of the mirror 114 will be fixed after the wavelength of the probe beam 103 has been determined using the fringe pattern created by movement of the mirror 114 as described above. After the position of the mirror 114 is fixed the laser is scanned through a range of wavelengths. The scanning of the wavelength of the probe beam 103 produces a set of interference fringes, corresponding to the changing wavelength of the probe beam 103 as it is transmitted through the interferometer and into the photoacoustic cell 112. Given that the scanning of the laser probe beam starts from a known position and the relative wavelength change of the probe beam can be determined by analyzing the fringe pattern 134 as is generally illustrated by FIG. 2B. The difference between adjacent minimums of the fringe pattern 134 corresponds to the frequency shift, where the change in frequency is equal to, or proportional to, the inverse of the differential interferometer time (τ). This is because the fringe pattern 134 also exists in frequency tuning space, where the fringe spacing is proportional to the reciprocal of the interferometer differential delay time. Thus, counting fringes allows computation of frequency change of the laser. The processor of the computer can be programmed to determine both the relative wavelength change and the absolute wavelength of the probe beam input to the photoacoustic cell 112. If the laser 102 mode hops while it is being swept across a range of different frequencies, a discontinuity or disruption on in the fringe pattern 134 will signal the mode hop of the laser beam wavelength.

Depending on absorptive characteristics of the of material being tested in the photoacoustic cell 112, and potentially other elements of the system it is possible that the interferometric fringe pattern, or the ripple generated by the interferometer, could possibly interfere with detection absorptive characteristics of the material being tested. Ideally, the ripple or fringe pattern should be significantly faster than the fastest periods of interest in the fingerprint of material under test in the photoacoustic cell. Thus, if for example the material under test is an absorptive gas having a pressure broadened width characteristic wave number in the range of 0.1 cm-1 atm, then the ripple period should be in the range of about 0.01 cm-1 atm, or if this is not possible then the ripple period should be such that the laser is swept across a linear quadrature point of the interferometer to provide a signal yielding laser tuning based on interferometer slope discrimination.

Recognizing that in some situations it could be advantageous to separate the determination of the fringe pattern, and the effect of the interferometer, from the detection of the absorptive qualities of the material under test an alternative embodiment system 300 is provided, as shown in FIG. 3. In the system 300 many of the same components are used as were used the system shown in FIG. 1A. Where the same components are used the same reference numbers have been provided so as to simplify the discussion herein. The system 300 is different than the system 100, in that it provides for a photoacoustic cell 142 in which an analyte known to very absorptive is present. A photoacoustic detector 144 is provided which senses absorbed energy which is emitted by the analyte in photoacoustic cell 142. Because the analyte in the photoacoustic cell 142 is strongly absorptive, the energy absorption signal 148 output by the photoacoustic detector 144 will be a relatively strong signal across most, if not all of the wavelength range of the laser beam 103 generated by the laser source 102. Thus, the energy absorption signal 148 can provide rich data across the full wavelength range so that the precise wavelength can be obtained across the full range. Note that in system 300 the analyte in photoacoustic cell 142 is not necessarily the same material which is actually being tested to determine its absorptive qualities. In fact, in the system 300 the analyte in the photoacoustic cell 142 is generally not same material as the analyte in the photoacoustic cell 138, and is instead selected to be a material which is strongly absorptive and which will operate as a type of reference which allows the wavelength of the laser beam to be detected. Photodetectors or detectors sensitive to heat created by the absorption of optical radiation could be used to realize the function of cell 142.

The system 300 provides a beam splitter 136 prior to the interferometer 105. The beam splitter 136 reflects part of the laser beam 103 into an analyte cell 138 which contains a material which is being tested to determine is absorptive characteristics. Beam splitter 136 can be placed elsewhere in system 300 so long as it provides optical energy to analyte cell 138. Another part of the laser beam 103 is transmitted through the beam splitter 136, and into the interferometer 105. The interferometer operates to create an interference fringe pattern in the laser beam which is transmitted into the photoacoustic cell 142. The system operates so that the output from the detector 144 is used to determine the wavelength of the laser beam 103, and the absorptive energy signal 146 from the detector 140 is used to determine the absorptive characteristics of the material being tested in the photoacoustic cell 138. Given that the laser beam 103 is simultaneously transmitted in the photoacoustic cell 138 and the photoacoustic cell 142 the absorptive characteristics of the of the material in the photoacoustic cell 138 can be correlated with the laser beam 103 wavelength as determined from the absorptive energy signal 148 from the photoacoustic cell 142. Thus, system 300 provides for separation of the wavelength determination and the detection of the absorptive qualities of the material which is contained in the photoacoustic cell 138. The operation of system 300 can provide benefits where the pressure broadened response of the material being analyzed in the photoacoustic cell is not significantly broader than the ripple period in the laser beam which is created by the interferometer, or where the material being analyzed has relatively low absorptive properties, which can make it difficult to determine the fringe pattern created by the interferometer.

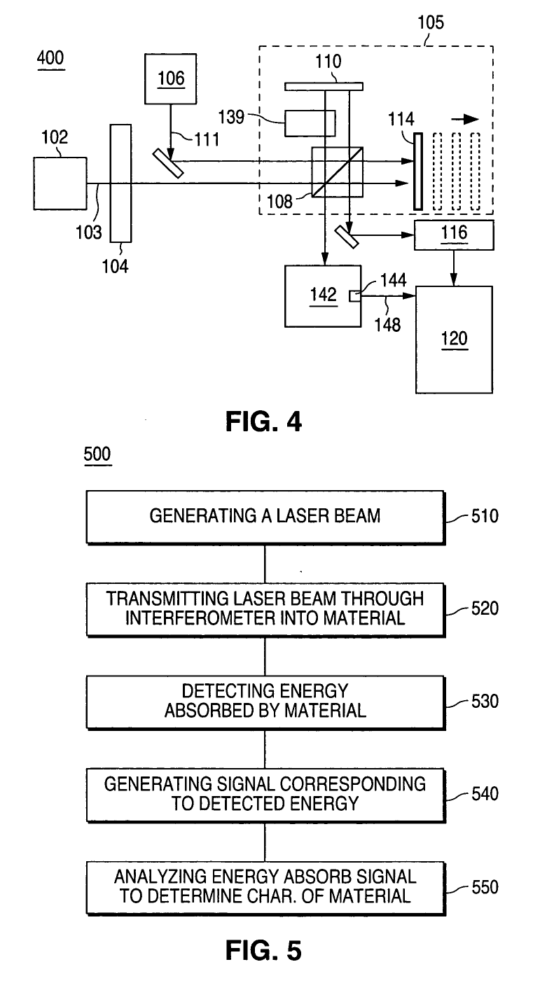

The system 400 shown in FIG. 4, illustrates another embodiment of a system herein. To reduce unnecessary duplication of discussion, where applicable the same reference numerals have been used in FIG. 4, as were used in connection with FIG. 3. The system 400 provides an analyte cell 139, which is located between the beamsplitter 108 and one of the two mirrors 110 or 114. Analyte cell 139 does not necessarily contain a detector, as detection can be performed with detector 144 of the photoacoustic cell 142, which detects the interference between the two paths of the interferometer. Two beams, 103 and 111, are transmitted into the interferometer 105. The beam 103 originates from the wavelength tunable mid-IR laser source, while beam 111 either originates from the same mid-IR source, or from a stable laser source 106 (e.g. HeNe gas laser). One interferometric path, contains the analyte cell 139 for analyte measurement, a second path of the interferometer, which beam 111 would travel, bypasses the cell 139 and is used for the purposes of wavelength measurement in conjunction with photoacoustic detector 144. The interferometer 105 operates to create an interference fringe pattern in the laser beam which is transmitted into the photoacoustic cell 142 for analyte measurement. The system operates so that the output 148 from the detector 144 is used to determine the wavelength of the laser beam 103, and the absorptive energy signal 148 is used as well to determine the absorptive characteristics of the material being tested in the analyte cell 139. If the absorption versus wavelength of the material such as a gas is known, the gas chromatic dispersive properties can be calculated to allow correction of the wavelength data. Calculation of dispersion from absorption is known in the art and is discussed in for example, A. Motamedi, B, Szafraniec, P. Robrish, D. M. Baney, “Group Delay Reference Artifact Based on Molecular Gas Absorption”, in Optical Fiber Communications Conference, OSA Technical Digest series (Optical Society of America, Washington, D.C., 2001) paper ThC8, which is incorporated herein by reference. Thus, system 400 provides for wavelength determination and the detection of the absorptive qualities of the material which is contained in the cell 139. The operation of system 400 can provide benefits where an extremely lossy analyte can still be measured due to the effective gain produced by the mixing with the optical field in the alternate non-lossy path in the interferometer. Moreover, this mixing can provide access to the phase response of the analyte as determined by the phase of the interferometric fringe pattern, or by measuring the phase of detected modulation sidebands in beam 103 from a phase or amplitude modulated optical source. Aspects of making measurements using the phase of detected modulation sidebands 103 from a phase or amplitude modulated optical source are taught in pending U.S. patent application Ser. No. 10/623,403 (US publication no. 20050012934) (entitled OPTICAL ANALYZER AND METHOD FOR MEASURING SPECTRAL AMPLITUDE AND PHASE OF INPUT OPTICAL SIGNALS USING HETERODYNE ARCHITECTURE) which is incorporated herein by reference in its entirety. Alternatively, the laser emission in system 400 can have a broad linewidth such that the Fourier Transform of absorption signal 148 provides for the loss spectrum of the analyte cell from which its chemical constituents are determined. In this case the second interferometric light path corresponding to beam 111 may originate from light coupled in through a stable laser (e.g. HeNe) and silicon detection 116 is used in order to measure precisely mirror position with time.

It should be noted that a range of different types of detectors can be used for detecting the energy absorbed by the material, these detectors can take the form of an individual detector or an array of detectors. One specific type of detector which has become widely used in connection mid-IR measurement is the Mercury Cadmium Telluride detector sometimes referred to as an MCT infrared detector. This MCT detector is an example of a detector which could be used with an embodiment of a system herein.

FIG. 5 is a flow chart which illustrates a method 500 of an embodiment herein. The method starts with generating 510 a laser probe beam which is input into an interferometer. The laser beam is then transmitted 520 through the interferometer and into a material being analyzed. In one embodiment this material being analyzed in disposed in a photoacoustic cell. The energy absorbed by the material is then detected 530, and an energy absorption signal is generated 540 which corresponds to the absorption of the laser beam energy by the material. The energy absorption signal is then analyzed 550 to determine characteristics of the material. As described in connection with the alternative embodiments of the systems above, the interferometer can be a tunable interferometer. The interferometer can be tuned, or adjusted, as for example by adjusting the position of a mirror in the interferometer. This tuning of the interferometer will create a series of fringe patterns in the laser beam which is input to the material being tested. The interference fringe pattern information can be detected in the energy absorption signal and analyzed to determine the wavelength of the laser beam.

An embodiment of the method also provides for sweeping the wavelength of the laser beam through a range of wavelengths. The absorption characteristics of the materials at different frequencies can then be used to generate an absorption fingerprint graph such as shown in FIG. 1C.

In one embodiment the laser beam wavelength is held at a fixed value, and the tuning interferometer is tuned to determine the fixed wavelength. At this point the interferometer is held in a fixed position, and the laser source then operates to sweep the wavelength of the laser beam through a range of wavelengths. As the wavelength of the laser is swept, the fringe pattern, or ripple created by the interferometer can be monitored, and used to determine relative change in the wavelength. Given, that the sweeping of the wavelength started from a known one wavelength, the absolute value of the wavelength can be determined. The absorptive characteristics of the material are tracked relative to the wavelength of the laser beam. The absorptive characteristics of the material can then be used to identify the molecular content of the material.

In one embodiment the method of operation can provide for starting at a number of different wavelengths, and then determining the wavelength, and sweeping through some range of wavelengths from the initially selected starting wavelength. The basic operation is setting the laser source to output a new starting wavelength for analysis of the absorption of the molecule under test. The scanning mirror then provides a series of interference fringes, these fringes are measurable due the absorption of the analyte causing an acoustic wave setup in the photoacoustic cell which is measured using a photoacoustic detector. As the mirror scans, the interference signal provides a measure of the wavelength of the laser, which can be generally determined from the fringe period, as corrected for the index of refraction of the beams propagating in the interferometer.

When the laser wavelength is then subsequently continuously scanned from the fixed known wavelength, and the scanning mirror is held in a fixed position, a ripple is produced in the detected signal versus wavelength tuning. This ripple can be used to provide precise measure of the mode-hop free tuning since the free-spectral range of the interferometer is known for the fixed mirror position. Recording the absorption of the analyte versus the wavelength provides the absorption information needed to determine the molecule and concentration of the molecule in photoacoustic cell.

Although a free-space Mach-Zehnder type interferometer was described in the implementation of the present invention, other types of interferometers, free-space or in integrated or fiberoptic arrangements could also be used. For example, interferometers known by names such as Michelson, Fabry-Perot and others that provide for an original optical beam plus one or more delayed replica beams to enable interference are suitable.

Although only specific embodiments of the present invention are shown and described herein, the invention is not to be limited by these embodiments. Rather, the scope of the invention is to be defined by these descriptions taken together with the attached claims and their equivalents.

What is claimed is:

1. A system for analyzing a material, the system including:
a laser source which outputs a laser beam;
an interferometer which receives the laser beam, and transmits the laser beam into a material being tested;
a detector which generates an energy absorption signal corresponding to an energy absorbed by the material as a result of the laser beam being transmitted into the material; and
a processor which analyzes the energy absorption signal to determine a characteristic of the material being tested.

2. The system of claim 1, further wherein:
the interferometer includes a movable mirror, wherein the mirror of the interferometer is movable through a range of different positions to provide a series of interference fringes in the laser beam transmitted into the material.

3. The system of claim 2, further including:
wherein the processor is operative to analyze the energy absorption signal to determine a wavelength of the laser beam.

4. The system of claim 1, wherein the laser source includes a QCL laser.

5. The system of claim 1, wherein the laser source includes a multi-sectional laser.

6. The system of claim 1, further including:
a photoacoustic cell in which the material being analyzed is disposed.

7. The system of claim 6, wherein the detector is disposed in the photoacoustic cell, and the detector is a photoacoustic detector.

8. The system of claim 1, wherein the laser beam has a wavelength in the range of 3 to 30 microns.

9. The system of claim 1, wherein the laser source includes a tunable laser.

10. The system of claim 1, further including:
a reference laser which outputs a reference laser beam;
wherein the reference laser beam is transmitted through the interferometer to a reference detector, which outputs a reference signal;
wherein the reference signal is analyzed by the processor to determine characteristics of the interferometer.

11. A system for analyzing a material, the system including:
a laser source which outputs a laser beam;
a beam splitter which splits the laser beam into a first component and a second component;
a first photoacoustic cell in which the material being analyzed is disposed, wherein the first component of the laser beam is input into the first photoacoustic cell, and wherein a first detector is included in the first photoacoustic cell, and the first detector generates an energy absorption signal corresponding to an energy absorbed by the material as a result of the first component laser beam being transmitted into the material;
a processor which analyzes the energy absorption signal to determine a characteristic of the material being tested;
an interferometer which receives the second component of the laser beam, and transmits the second component of the laser beam toward a second detector;
wherein the second detector generates a second energy absorption signal in response to the second component of the laser beam;
wherein the processor analyzes the second energy absorption signal to determine a wavelength of the laser beam.

12. The system of claim 11, further wherein:
the interferometer includes a movable mirror, wherein the mirror of the tunable interferometer is movable through a range of different positions to provide a series of interference fringes in the second component of the laser beam transmitted into the reference material.

13. The system of claim 11, wherein the laser source includes a QCL laser.

14. The system of claim 11, wherein the laser source includes a multi-sectional laser.

15. A method for analyzing a material, the method including:
generating a laser beam;
transmitting the laser through an interferometer and into the material;
detecting an energy absorbed by the material as a result of the laser beam being transmitted into the material;
generating an energy absorption signal corresponding to the detected energy;
analyzing the energy absorption signal to determine a characteristic of the material.

16. The method of claim 15, further including:
analyzing the amount of energy absorbed by the material relative to the wavelength of the laser beam to identify the composition of the material.

17. The method of claim 15, further including:
tuning the interferometer to produce a series of fringe patterns in laser beam.

18. The method of claim 17, further including:
analyzing the series of fringe patterns to determine the wavelength of the laser beam.

19. The method of claim 15, wherein laser beam has a wavelength in the range of 3 to 30 microns.

20. The method of claim 15, further including:
sweeping the laser beam through a range of frequencies; and
determining absorption characteristics of the material at different frequencies.

21. A system for analyzing a material, the system including:
a laser source which outputs a laser beam;
an interferometer which receives the laser beam, the interferometer including a beam splitter which splits the laser beam into a first component and a second component, wherein the first component travels a first path of the interferometer and the second component travels a second path of the interferometer, wherein the first path and the second path are such that the first component and the second component are recombined and the recombined laser beam is transmitted into a photoacoustic cell;
a cell containing the material which is disposed in the first path of the interferometer such that the first component travels through the cell containing the material;
a detector disposed in the photoacoustic cell which outputs a signal in response to the laser beam transmitted into the photoacoustic cell;
a processor which receives the signal and analyzes the signal to determine characteristics of the material.
